(19) United States
(12) Patent Application Publication
(10) Pub. No.: US 2013/0068192 A1
(43) Pub. Date: Mar. 21, 2013

(54) FUEL EXHAUST PREVENTION STRUCTURE OF ENGINE

(71) Applicants: Jong Kil Lim, Anyang-si (KR); Sang II Yoon, Anyang-si (KR); Tae Young Kim, Gunpo-si (KR)

(72) Inventors: Jong Kil Lim, Anyang-si (KR); Sang II Yoon, Anyang-si (KR); Tae Young Kim, Gunpo-si (KR)

(73) Assignee: Hyundai Motor Company, Seoul (KR)

(21) Appl. No.: 13/316,435

(22) Filed: Dec. 9, 2011

(30) Foreign Application Priority Data
Sep. 20, 2011 (KR) 10-2011-0094848

(51) Int. Cl. F02B 77/00

(52) U.S. Cl. 123/198 R

(57) ABSTRACT

A fuel exhaust prevention structure of an engine may include a fuel pipe mounted on the engine and provided outside the engine, and a connector having one end that may be inserted onto an end of the fuel pipe and the other end that may be provided with a shutoff valve to be selectively opened and closed.

### CROSS-REFERENCE TO RELATED APPLICATION

The present application claims priority to Korean Patent Application No. 10-2011-0094848, filed on Sep. 20, 2011 in the Korean Intellectual Property Office, the entire contents of which is incorporated herein for all purposes by this reference.

### BACKGROUND OF THE INVENTION

1. Field of the Invention

The present invention relates to a fuel exhaust prevention structure of an engine, and more particularly, to a fuel exhaust prevention structure of an engine, which can prevent fuel from dropping from an engine that is transported in a component assembling line.

2. Description of Related Art

In general, an engine is a power unit which is used in a vehicle and the like and uses gasoline or volatile oil as fuel. An engine may be classified into a rotary engine and a reciprocating engine, and generally, an engine means a reciprocating engine. The reciprocating engine obtains power through intake, compression, explosion, and exhaust of mixed gas as a piston is reciprocating in the engine.

The engine that is the reciprocating engine includes an engine block that is an engine main body, a piston assembled in a bore of the engine block to perform an up/down linear reciprocating motion through explosion of the mixed gas, a connecting rod rotating by the linear reciprocating motion of the piston, and a crankshaft.

Since the piston directly receives pressure when the mixed gas is combusted and continuously repeats the high-speed linear reciprocating motion in the engine block, it requires light weight, high strength, and small thermal expansion. Further, combustion pressure of about 30 to 40 kg/cm² occurs in the engine during the explosion stroke, and in order to operate the piston by the pressure, it is required to make the gap between the piston and the bore of the engine block almost zero.

For this, a piston ring is typically provided on the piston to fill up the gap between the piston and the bore of the engine block so as to prevent the pressure of the mixed gas from leaking. Further, a compression ring for preventing oil from flowing into a combustion chamber through a bore wall surface and an oil ring for the purpose of oil lubrication are provided on the piston. Through the operations of the above-described rings, the airtight of the engine block is maintained.

While such an engine is transported to be mounted on a vehicle, fuel may drop from the engine to a workshop of a factory.

FIG. 1 is a view illustrating a fuel exhaust prevention structure of an engine in the related art.

The fuel exhaust prevention structure of an engine in the related art, as illustrated in FIG. 1, includes a fuel pipe 11 mounted on an engine 10 and provided outside the engine 10, and a rubber cap 20 inserted onto an end of the fuel pipe 11 to cover the fuel that flows to the outside through the fuel pipe 11.

In the related art, the fuel exhausts after testing the engine 10 and the end of the fuel pipe 11 is covered by the rubber cap 20. However, if the rubber cap 20 is removed to connect the fuel pipe 11 of the engine 10 to a fuel pipe which is connecting to a fuel tank of a vehicle (not illustrated), the fuel that flows to the lower side of the fuel pipe 11 due to its own weight drops to pollute the bottom of the workshop.

On the other hand, if the fuel pipe is connected to a fuel pipe which is connecting to a fuel tank of a vehicle after the fuel inside the engine 10 completely exhausts in order to prevent the fuel from dropping from the engine 10, an initial start of the engine is delayed in a fuel filling process after assembling the vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a fuel exhaust prevention structure of an engine, which can prevent fuel from dropping from an engine while the engine is transported in a component assembling line.

In one aspect of the present invention, a fuel exhaust prevention structure of an engine, may include a fuel pipe mounted on the engine and provided outside the engine, and a connector having one end that is inserted onto an end of the fuel pipe and the other end that is provided with a shutoff valve to be selectively opened and closed.

The connector may include an open connector and a closed connector which are integrally formed, and the open connector opens and the closed connector selectively opens.

The closed connector may include an opening member installed in an inner surface thereof and selectively opened or closed.

A first insertion hole is formed in the open connector and the end of the fuel pipe is inserted into the first insertion hole, and a second insertion hole is formed in the closed connector, wherein a fuel pipe from an outside is selectively received into the second insertion hole, and wherein the opening member is opened while the fuel pipe presses the opening member.

The open connector and the closed connector are integrally connected to each other.

The fuel exhaust prevention structure may further include a casing for covering the open connector and the closed connector.

The fuel pipe may include a first fuel pipe and a second fuel pipe, and the connectors are inserted into the first fuel pipe and the second fuel pipe, respectively.

A fuel exhausts through the first fuel pipe from the engine and a fuel is filled inside the engine through the second fuel pipe.

As described above, according to the present invention, since the fuel is prevented from dropping from an engine while the engine is transported in an assembling line, an unnecessary loss of fuel and manpower is prevented to improve the productivity and workability. Further, delay of an initial start of the vehicle is prevented after the vehicle is assembled, and thus the merchantability is improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a fuel exhaust prevention structure of an engine in the related art.

FIG. 2 is a view illustrating a fuel exhaust prevention structure of an engine according to an exemplary embodiment of the present invention.

FIGS. 3A and 3B are views illustrating an open connector and a closed connector in a fuel exhaust prevention structure of an engine according to an exemplary embodiment of the present invention.

FIG. 4A is a cross-section view illustrating an open connector in a fuel exhaust prevention structure of an engine according to an exemplary embodiment of the present invention.

FIG. 4B is a cross-section view illustrating a closed connector in a fuel exhaust prevention structure of an engine according to an exemplary embodiment of the present invention.

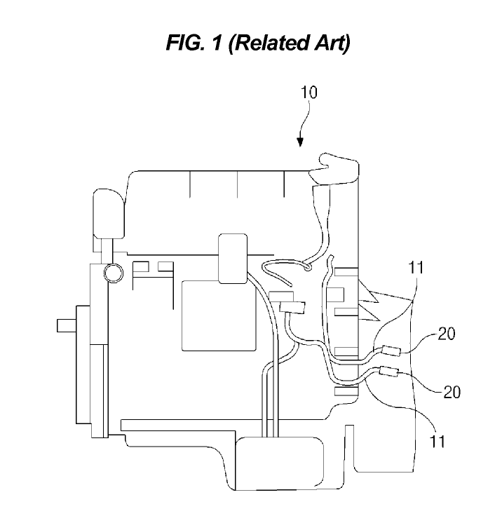

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, preferred embodiments of the present invention will be described with reference to the accompanying drawings.

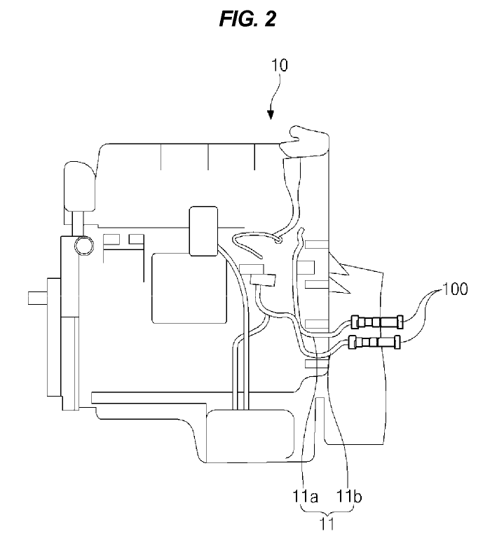

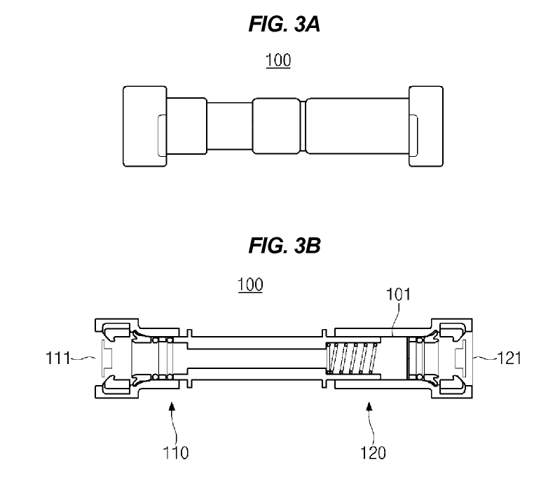

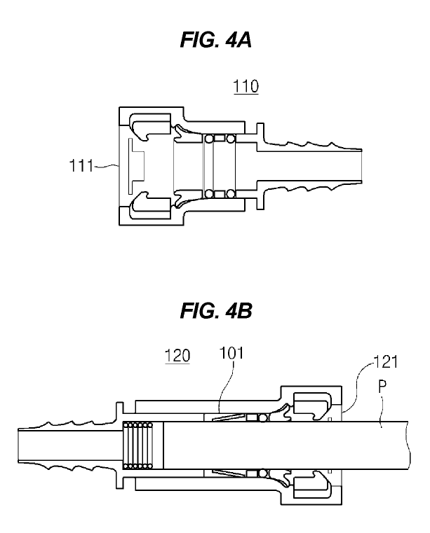

FIGS. 2 to 4B illustrate a fuel exhaust prevention structure of an engine according to an embodiment of the present invention. FIG. 2 is a view illustrating a fuel exhaust prevention structure of an engine according to an exemplary embodiment of the present invention, FIGS. 3A and 3B are views illustrating an open connector and a closed connector in a fuel exhaust prevention structure of an engine according to an exemplary embodiment of the present invention, and FIGS. 4A and 4B are cross-section views illustrating an open connector and a closed connector in a fuel exhaust prevention structure of an engine according to an exemplary embodiment of the present invention.

As illustrated in FIGS. 2 to 4B, a fuel exhaust prevention structure of an engine according to an exemplary embodiment of the present invention includes a fuel pipe 11 mounted on an engine 10 and provided outside the engine 10 and a connector 100 having one end that is inserted onto an end of the fuel pipe 11 and the other end that is provided with a shutoff valve 101 to be selectively opened and closed, and prevents the fuel from dropping from the engine 10.

Hereinafter, constituent elements of the fuel exhaust prevention structure of an engine according to an exemplary embodiment of the present invention will be described one by one with reference to the accompanying drawings.

First, as illustrated in FIG. 2, the fuel exhaust prevention structure of an engine according to an exemplary embodiment of the present invention basically includes the fuel pipe 11 mounted on the engine 10, and the connector 100 inserted onto the fuel pipe 11.

The fuel pipe 11 is mounted on the engine 10. One end of the fuel pipe 11 is inserted into the inside of the engine 10, and the other end thereof is provided outside the engine 10. Preferably, the first fuel pipe 11a makes the fuel exhaust from the engine 10, and the second fuel pipe 11b makes the fuel filled inside the engine 10.

As illustrated in FIGS. 2, 3A and 3B, the connector 100 is to prevent the fuel from dropping imprudently from the fuel pipe 11. The connector 100 is in a pipe shape, and one end of the connector 100 is inserted onto the end of the fuel pipe 11.

On the other hand, since the fuel pipe 11 mounted on the engine 10 includes plural fuel pipes, that is, the first fuel pipe 11a and the second fuel pipe 11b, it is preferable that plural connectors 100 are provided to be inserted onto the ends of the first fuel pipe 11a and the second fuel pipe 11b.

Further, on the other end of the connector 100, the shutoff valve 101 is provided to selectively open and close the connector 100.

It is preferable that the connector 100 includes an open connector 110 and a closed connector 120, and the open connector 110 and the closed connector 120 are connected together to form a single connector 100.

Further, it is preferable that on the outside of the open connector 110 and the closed connector 120 connected together, a casing for covering the open connector 110 and the closed connector 120 is formed.

In this case, it is preferable that a first insertion hole 111 is formed in the open connector 110 and the end of the fuel pipe 11 is inserted into the first insertion hole 111, and a second insertion hole 121 is formed in the closed connector 120 and a fuel injection pipe P (refer to FIGS. 4A and 4B) from an outside is inserted into the second insertion hole 121.

As illustrated in FIGS. 4A and 4B, the open connector 110 has an open structure in which the inside thereof is penetrated. The shutoff valve 101 is provided inside the closed connector 120 to form a selectively closed structure, and only in the case where the fuel pipe P which is connecting to a fuel tank of a vehicle is inserted from the outside, the closed connector 120 is opened.

In an exemplary embodiment of the present invention, the shutoff valve 101 includes an opening member 125 which is elastically supported or made up of elastic material.

As described above, if the fuel pipe P is not inserted into the closed connector 120 in a state where the open connector 110 and the closed connector 120 are connected together, the closed connector 120 is closed by the opening member 125 of the shutoff valve 101 to which an elastic force is applied, and thus the fuel that exhausts through the fuel pipe 11 is prevented from exhausting to the outside of the closed connector 120.

On the other hand, if the fuel pipe P which is connected to a fuel tank of a vehicle is inserted through the second insertion hole 121 of the closed connector 120, the fuel pipe P opens the opening member 125 of the shutoff valve 101, and the fuel exhausting through the fuel pipe 11 passes through the open connector 110 and the closed connector, and exhausts into the fuel pipe which is connecting to the outside, for example a fuel tank of a vehicle. Further, after the vehicle is assembled, the fuel that is injected from the fuel pipe P is transported to the fuel pipe 11 through the closed connector 120 and the open connector 110, and is filled in the engine 10.

As described above, the fuel exhaust prevention structure of an engine according to an exemplary embodiment of the present invention includes the fuel pipe mounted on the engine and provided outside the engine and the connector having one end that is inserted onto the end of the fuel pipe and the other end that is provided with the shutoff valve to be selectively opened and closed, and prevents the fuel from dropping from the engine while the engine is transported in the assembling line. Accordingly, an unnecessary loss of fuel and manpower is prevented to improve the productivity and workability, and delay of an initial start of the vehicle is prevented after the vehicle is assembled to improve the merchantability.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel exhaust prevention structure of an engine, comprising:
a fuel pipe mounted on the engine and provided outside the engine; and
a connector having one end that is inserted onto an end of the fuel pipe and the other end that is provided with a shutoff valve to be selectively opened and closed.

2. The fuel exhaust prevention structure of the engine according to claim 1,
wherein the connector includes an open connector and a closed connector which are integrally formed, and
wherein the open connector opens and the closed connector selectively opens.

3. The fuel exhaust prevention structure of the engine according to claim 2,
wherein the closed connector includes an opening member installed in an inner surface thereof and selectively opened or closed.

4. The fuel exhaust prevention structure of the engine according to claim 3,
wherein a first insertion hole is formed in the open connector and the end of the fuel pipe is inserted into the first insertion hole, and a second insertion hole is formed in the closed connector,
wherein a fuel pipe from an outside is selectively received into the second insertion hole, and
wherein the opening member is opened while the fuel pipe presses the opening member.

5. The fuel exhaust prevention structure of the engine according to claim 2, wherein the open connector and the closed connector are integrally connected to each other.

6. The fuel exhaust prevention structure of the engine according to claim 2, further comprising a casing for covering the open connector and the closed connector.

7. The fuel exhaust prevention structure of the engine according to claim 1, wherein the fuel pipe includes a first fuel pipe and a second fuel pipe, and the connectors are inserted into the first fuel pipe and the second fuel pipe, respectively.

8. The fuel exhaust prevention structure of the engine according to claim 7, wherein a fuel exhausts through the first fuel pipe from the engine and a fuel is filled inside the engine through the second fuel pipe.
